(19) United States
(12) Patent Application Publication
(10) Pub. No.: US 2026/0139968 A1
(43) Pub. Date: May 21, 2026

(54) USING ASSET MAPS TO INFORM REAL-TIME MACHINE LEARNING MODELS FOR UAV NAVIGATION

(71) Applicant: Wing Aviation LLC, Palo Alto, CA (US)

(72) Inventors: ALI SHOEB, San Rafael, CA (US); JEREMIE GABOR, Mountain View, CA (US); YUEYANG YING, New York City, NY (US); DINUKA ABEYWARDENA, Mountain View, CA (US)

(21) Appl. No.: 18/955,361

(22) Filed: Nov. 21, 2024

(51) Int. Cl. G01C 21/00; G06V 20/17; G08G 5/00

(52) U.S. Cl. CPC G01C 21/3852; G06V 20/17; G08G 5/55; G08G 5/57

(57) ABSTRACT

A technique for informing navigation of a UAV includes storing an asset map of a ground area, wherein the asset map includes a reference aerial image of the ground area annotated with labels describing reference objects depicted in the reference aerial image; acquiring a current aerial image of the ground area with an onboard camera system of the UAV while the UAV is flying above the ground area; mapping correspondences between the reference aerial image and the current aerial image using a homography estimating tool executing onboard the UAV; analyzing the current aerial image with an object detection model to detect a first object positioned at the ground area; and validating or informing a detection of the first object by the object detection model based on the mapping of the correspondences.

### TECHNICAL FIELD

This disclosure relates generally to vision-based navigation techniques for aerial vehicles, and in particular but not exclusively, relates to the use of homography to supplement vision-based navigation techniques for unmanned aerial vehicles (UAVs).

### BACKGROUND INFORMATION

An unmanned vehicle, which may also be referred to as an autonomous vehicle, is a vehicle capable of traveling without a physically present human operator. Various types of unmanned vehicles exist for various different environments. For instance, unmanned vehicles exist for operation in the air, on the ground, underwater, and in space. Unmanned vehicles also exist for hybrid operations in which multi-environment operation is possible. Unmanned vehicles may be provisioned to perform various missions, including payload delivery, exploration/reconnaissance, imaging, public safety, surveillance, or otherwise. The mission definition will often dictate a type of specialized equipment and/or configuration of the unmanned vehicle.

Unmanned aerial vehicles (also referred to as drones) can be adapted for package delivery missions to provide an aerial delivery service. One type of unmanned aerial vehicle (UAV) is a vertical takeoff and landing (VTOL) UAV. VTOL UAVs are particularly well-suited for package delivery missions. The VTOL capability enables a UAV to takeoff and land within a small footprint thereby providing package pick-ups and deliveries almost anywhere.

While global navigation satellite systems (GNSS) are often relied upon as the primary localization system to inform navigation decisions of a UAV, GNSS may not be available in all areas (e.g., due to GNSS shadows, multipath reflections, etc.) or may be insufficiently accurate in some situations, such as package pickups and drop-offs, landings, or otherwise. Accordingly, vision-based navigation techniques may be used to buttress GNSS and provide fallback localization and/or higher precision localization when necessary.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates operation of an unmanned aerial vehicle (UAV) delivery service that delivers packages into a neighborhood, in accordance with an embodiment of the disclosure.

FIG. 2 is a functional block diagram illustrating a system for localizing and navigating a UAV based upon GNSS and vision-based navigation modules, in accordance with an embodiment of the disclosure.

FIGS. 3A & 3B are a flow chart illustrating a process for using asset maps and homography mapping to inform semantic machine learning (ML) models while navigating a UAV, in accordance with an embodiment of the disclosure.

FIG. 4A illustrates a reference aerial image of a ground area including reference objects annotated in the reference aerial image, in accordance with an embodiment of the disclosure.

FIG. 4B illustrates a current aerial image acquired in real-time by a UAV flying above the ground area, in accordance with an embodiment of the disclosure.

FIG. 4C illustrates mapping of correspondences between the reference aerial image and the current aerial image by a homography estimating tool, in accordance with an embodiment of the disclosure.

FIG. 4D illustrates the current aerial image annotated based upon a homography mapping, in accordance with an embodiment of the disclosure.

FIG. 5A is a perspective view illustration of a UAV configured for use in a UAV delivery system, in accordance with an embodiment of the disclosure.

FIG. 5B is an underside plan view illustration of the UAV configured for use in the UAV delivery system, in accordance with an embodiment of the disclosure.

### DETAILED DESCRIPTION

Embodiments of a system, apparatus, and method of operation that uses homography mapping between asset maps and aerial images to inform or otherwise validate real-time detections of objects on the ground by semantic machine learning (ML) models of a unmanned aerial vehicle (UAV) are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments described herein leverage a homography estimating tool to map correspondences between a reference asset map and a current aerial image captured by a UAV while flying. The correspondence mapping (aka “feature matching”) enables accurate annotation of the real-time aerial images with reference objects (also referred to as “assets”), which can inform the navigation decisions of the UAV. In particular, the asset annotations may be used by the UAV to inform or validate the real-time object detections performed by machine learning (ML) models (e.g., object detection models) executed onboard the UAV. These object detection models are submodules of the UAV's machine vision system that enable it to navigate within an environment relative to the objects present in that environment based on its machine vision and detection of those objects. Asset validation is a sort of cross-checking that improves the reliability of the real-time detections performed by the various onboard vision-based object detection models. Example object detection models that may be validated, or otherwise informed by feature matching, include ML models trained to detect particular assets of an aerial delivery service. Such assets may include autoloaders for automatically loading packages onto UAVs for waypoint pickups, charge pads for charging the UAVs of a UAV delivery fleet, and fiducial navigation markers (e.g., April Tags) adapted for visual navigation by the UAVs. In addition to validating, cross-checking, or otherwise informing the detections output from real-time object detection models, the homography estimating tool may also be used for localization of the UAV by mapping correspondences between a current aerial image and a reference aerial image having geolocation labels. In one embodiment, the UAV transitions from vision-based navigation primarily based on homography feature matching to vision-based navigation primarily based on object detections by its onboard object detection models. The transition may be altitude driven. At higher altitudes navigation decisions may be biased towards homography feature matching while at lower altitudes navigation decisions may be biased towards object detections as those objects fill greater portions of the machine vision field of view (FOV) and are more easily detected by semantic segmentation models. These and other features are described in further detail below.

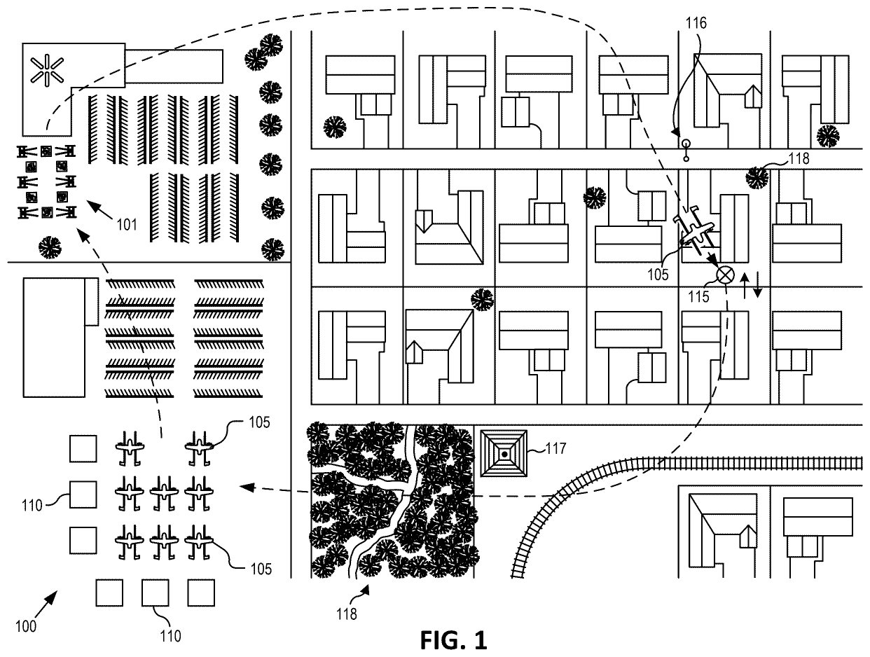

FIG. 1 illustrates operation of a UAV delivery service that delivers packages into a neighborhood, in accordance with an embodiment of the disclosure. UAVs may one day routinely deliver items into urban or suburban neighborhoods from small regional or neighborhood hubs such as terminal area 100 (also referred to as a local nest or staging area). Vendor facilities that wish to take advantage of the aerial delivery service may set up adjacent to terminal area 100 (such as vendor facilities 110) or be dispersed throughout the neighborhood for waypoint package pickups using autoloader devices staged adjacent to the vendor facilities (such as waypoint pickup area 101). An example aerial delivery mission may include multiple mission phases such as takeoff from terminal area 100 with a package for delivery to a destination area 115 (also referred to as a delivery zone, drop zone, or delivery destination), rising to a cruising altitude, and cruising to the customer destination. Alternatively, the UAV 105 may fly from terminal area 100 to waypoint pickup area 101 for package pickup, before continuing on to destination area 115. At destination area 115, UAV 105 descends for package drop-off before once again ascending to a cruise altitude for the return cruise back to terminal area 100.

During the course of a delivery mission, ground-based obstacles are an ever-present hazard—particularly tall slender obstacles such as streetlights 116, telephone poles, radio towers 117, cranes, trees 118, and utility lines. To facilitate an efficient and safe operation of the UAV delivery service, these obstacles must be avoided while assets of the UAV delivery service such as autoloaders, charging/landing pads, and fiducial navigation markers should be reliably detected and accurately tracked. Global navigation satellite systems (GNSS), such as the global positioning system (GPS) in North America, may form a primary localization and navigation subsystem of UAVs 105 for navigating to assets and around obstacles. However, in some situations, the GNSS system may be unavailable or insufficiently accurate. Accordingly, vision-based navigation modules may be used to buttress GNSS by providing fallback localization and/or higher precision localization when necessary.

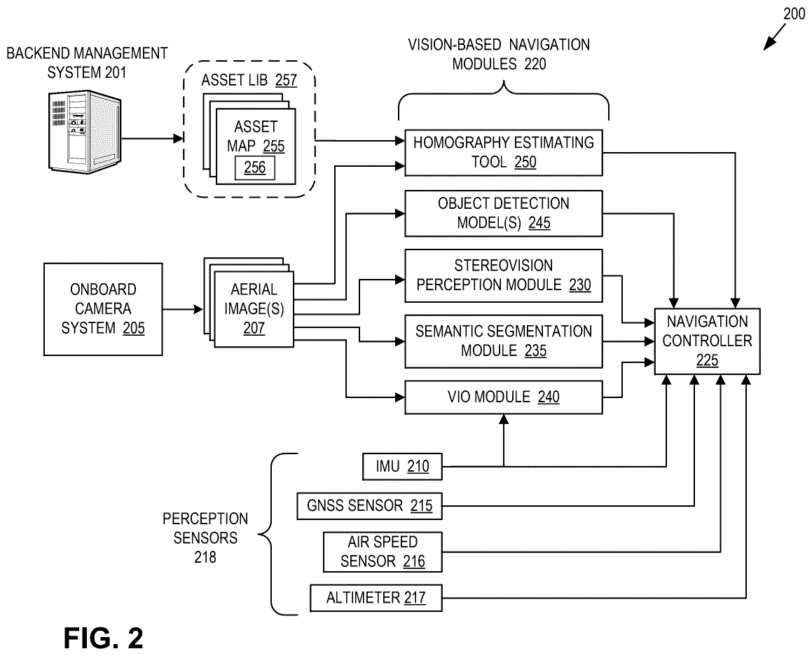

FIG. 2 is a functional block diagram illustrating a system 200 for localizing and navigating a UAV based upon GNSS and vision-based navigation modules including a homography estimating tool, in accordance with an embodiment of the disclosure. System 200 includes many of the relevant software and hardware elements disposed onboard UAVs 105 for sensing the environment (including detecting various assets of the UAV delivery service such as charge pads, autoloaders, and fiducial navigation markers) and navigating based upon its detections of these assets. The illustrated embodiment of system 200 includes an onboard camera system 205 for acquiring aerial images 207, an inertial measurement unit (IMU) 210, a GNSS sensor 215, an air speed sensor 216 (e.g., pitot tube), an altimeter 217 (e.g., air pressure sensor), machine vision modules 220, and a navigation controller 225. Collectively, the sensors 210-217 are referred to as perception sensors 218. The illustrated embodiment of machine vision modules 220 includes a stereovision perception module 230, a semantic segmentation module 235, a visual inertial odometry (VIO) module 240, one or more object detection models 245, and a homography estimating tool 250.

Onboard camera system 205 is disposed on UAVs 105 with a downward looking orientation to acquire aerial images 207 of the ground area below it. Aerial images 207 may be acquired at a regular video frame rate (e.g., 20 f/s, 30 f/s, etc.) and a subset of the images provided to the various machine vision modules 220 for analysis. In one embodiment, onboard camera system 205 is a stereovision camera system. While capturing aerial images 207, the camera intrinsics along with sensor readings from the onboard perception sensors 218 may be recorded and indexed to aerial images 207. For example, IMU 210 may include one or more of an accelerometer, a gyroscope, or a magnetometer to capture accelerations (linear or rotational), attitude, and heading readings. GNSS sensor 215 may be a global positioning system (GPS) sensor, or otherwise, and output longitude/latitude position, mean sea level (MSL) altitude, heading, speed over ground (SOG), etc. Air speed sensor 216 captures air speed of UAV 105 while underway, which may serve as a rough approximation for SOG when adjusted for weather conditions. Altimeter 217 measures air pressure, which provides MSL altitude, which may be offset using elevation map data to estimate above ground level (AGL) altitude.

During flight missions, machine vision modules 220 are operated as part of an onboard machine vision system and may constantly receive aerial images 207, referred to herein as current aerial images, and detect, identify, and track objects represented in those aerial images. Stereovision perception module 230 analyzes parallax between stereovision aerial images acquired by onboard camera system 205 to estimate distance to pixels/features/objects in aerial images 207. These stereovision depth estimates may be referred to as a stereovision depth map. VIO module 240 estimates the three-dimensional (3D) pose (e.g., position/orientation) of onboard camera system 205 of UAV 105 using aerial images 207 and IMU 210. In other words, VIO module 204 provides ego-motion tracking relative to the surrounding environment of UAV 105. Semantic segmentation module 235 uses image segmentation to inform object detection and identification (e.g., pixelwise classification) along with feature tracking within aerial images 207. Feature tracking includes the detection and tracking of features within aerial images 207. Features may include edges, corners, high contrast points, etc. of objects within aerial images 207. Recognized objects may be tracked and the classifications provided to other modules responsible for making real-time flight decisions. In one embodiment, object detection models 245 represent specific instances (trained neural network instances) of semantic segmentation module 235. In particular, object models 245 may include an autoloader detector model having a neural network trained to detect autoloaders of the UAV delivery service, a charge pad detector model having a neural network trained to detect charging/landing pads of the UAV delivery service, a fiducial marker detector having a neural network trained to detector fiducial navigation markers, or otherwise.

Homography estimating tool 250 is a machine vision tool that matches features or interest points in reference aerial images 256 of asset maps 255 to their corresponding features or interest points in current aerial images 207 acquired in real-time during a mission. In other words, homography estimating tool 250 performs a pixel-to-pixel mapping between two images. Homography estimating tool 250 may be implemented using a variety of tools including a feature extractor that pre-analyzes the images to identify interest points or features in each picture followed by a feature matcher for mapping those identified interest points or features to each other in the images. Features or interest points may include corners, lines, high contrast boundaries, etc. that are distinctly delineated in each of the images. In one embodiment, homography estimating tool 250 may be implemented using SuperPoint and SuperGlue available from Magic Leap, Inc. SuperPoint is a commercially available tool for extracting features from an image while SuperGlue is a commercially available tool for matching those features between two images.

Asset maps 255 may be assembled into an asset library 257 stored within local memory of UAVs 105. Asset library 257 is provisioned with relevant asset maps 255 from backend management system 201 prior to flying a mission. The relevant asset maps 255 for a given mission may include asset maps 255 of terminal area 100, any waypoint pickup locations along the preplanned flight path, and even destination area 115 in some situations. A given asset map 255 includes a reference aerial image 256 of the relevant ground area annotated with labels describing reference objects depicted in the reference aerial image 256. The reference objects may include a variety of ground based objects, but notably may include various assets of the UAV delivery services such as landing/charging pads, autoloaders, fiducial navigation markers (e.g., AprilTags), etc. Accordingly, each asset map 255 includes a reference aerial image 256 along with metadata. The metadata may include annotations of reference objects within the corresponding reference aerial image, descriptors for the reference objects (e.g., classification, object identifier, geolocation data, etc.), geolocation data for image pixels within the reference aerial images, etc. In embodiment, asset maps 255 are indexed within asset library 257 to vector embeddings and accessible via similarity searches using the vector embeddings. In other words, homography estimating tool 250 may execute a similarity search using distance calculations in vector space to identify the appropriate asset map 255 for a given location. In other embodiments, asset maps 255 are further indexed via geolocation, AGL altitude, time, weather conditions, etc. Accordingly, multiple asset maps 255 may be included within asset library 257 for a given ground area, but tailored for different altitudes, times, and/or weather conditions.

Collectively, vision-based navigation modules 220 provide vision-based analysis and understanding of the surrounding environment, which may be used by navigation controller 225 to inform navigation decisions and perform UAV localization, automated obstacle avoidance, route traversal, etc. Of course, the outputs from machine vision modules 220 may be combined with, or considered in connection with, real-time data from any of perception sensors 218 by navigation controller 225 to make informed vision-based navigation decisions. One of these informed vision-based navigation decisions is navigation relative to assets of the UAV delivery service deployed at terminal area 100 (e.g., landing pads, fiducial navigation markers, etc.) or assets deployed at a waypoint pickup location 101.

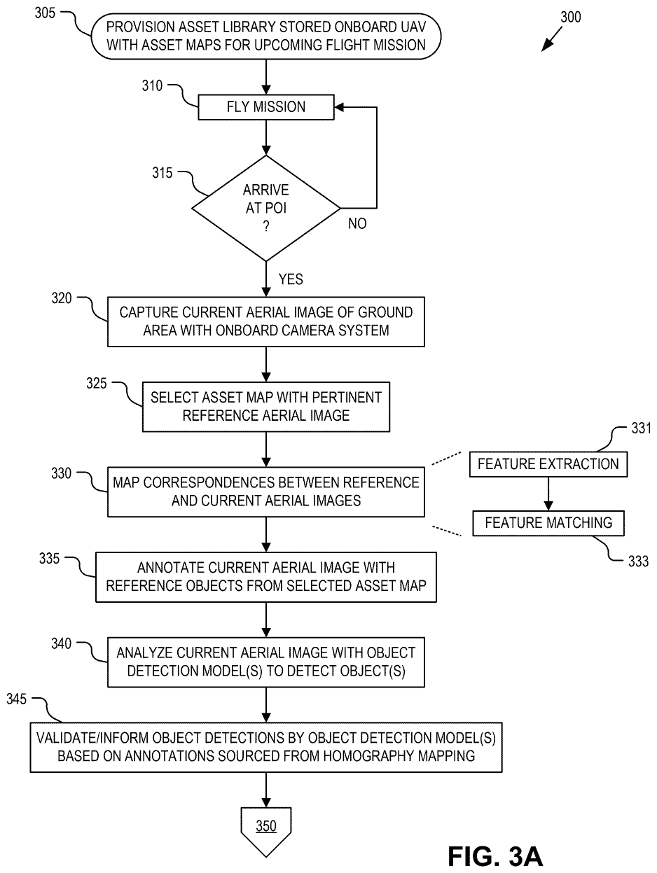

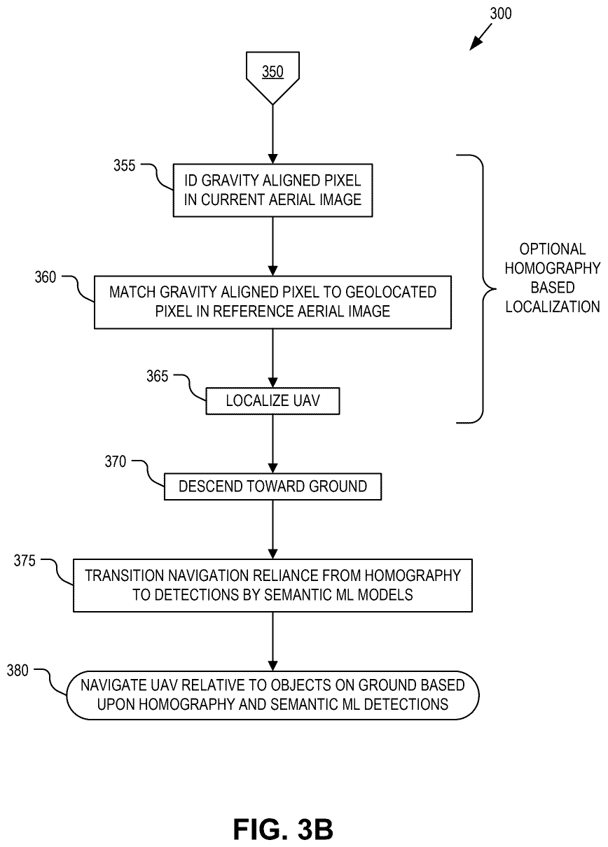

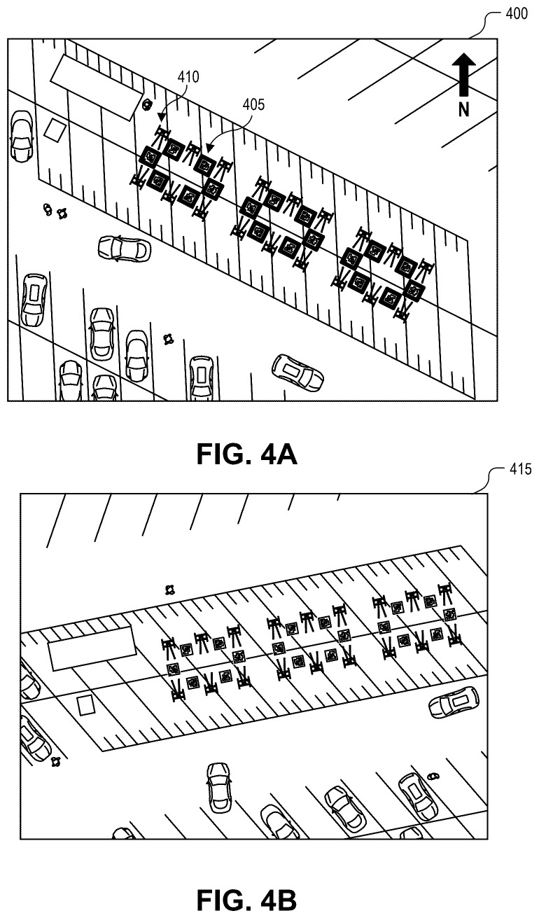

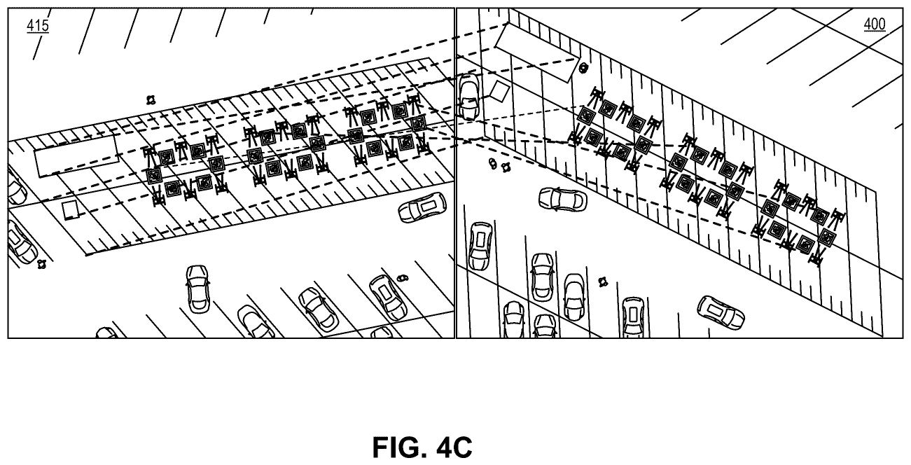

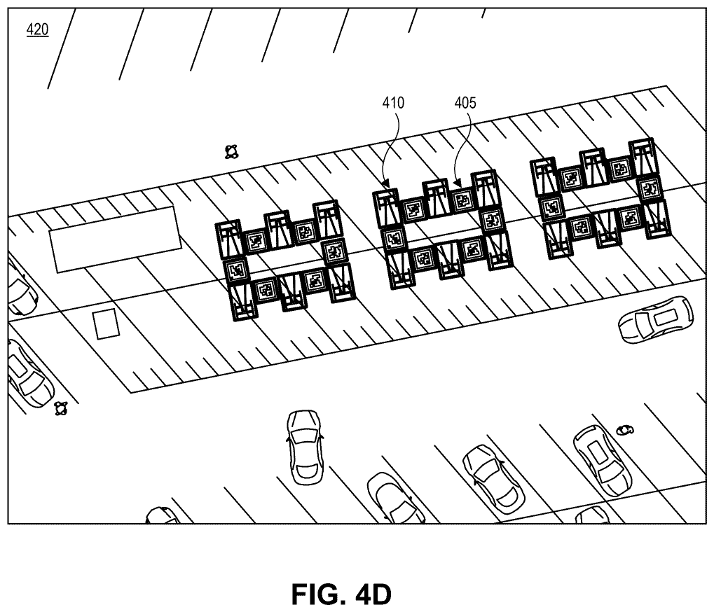

FIGS. 3A & 3B are a flow chart illustrating a process 300 for using asset maps 255 to inform object detection models 245 while navigating a UAV 105, in accordance with an embodiment of the disclosure. Process 300 is described with reference to FIGS. 2 and 4A-D. Although process 300 is described in connection with a UAV delivery service, it should be appreciated that the techniques described therein are applicable to other types of unmanned aircraft systems (UAS) configured to perform aerial services other than just package deliveries. The order in which some or all of the process blocks appear in process 300 should not be deemed limiting. Rather, one of ordinary skill in the art having the benefit of the present disclosure will understand that some of the process blocks may be executed in a variety of orders not illustrated, or even in parallel.

Prior to flying a given delivery mission, backend management system 201 provisions a designated UAV 105 with the requisite mission data to fly the delivery mission. This mission data includes not only a flight plan and flight path, but may also include various asset maps 255 corresponding to terminal area 100 and/or a waypoint pickup area 101 along the flight path. Each asset map 255 includes a corresponding reference aerial image 256 of a specified ground area annotated with labels describing reference objects (e.g., assets such as autoloaders, landing pads, fiducial navigation markers, etc.) depicted in the reference aerial image 256. FIG. 4A illustrates an example reference aerial image 400 of the ground area at waypoint pickup area 101. Reference aerial image 400 is an example of one of reference aerial images 256. Waypoint pickup area 101 includes various assets to support operations of the UAV delivery service including fiducial navigation markers 405 disposed about autoloaders 410 adapted for handing off packages to UAVs 105. Fiducial navigation markers 405 facilitate vision-based navigation about autoloaders 410. Reference aerial image 400 is annotated with labels describing (e.g., identifying, geolocating, etc.) the fiducial navigation markers 405 and autoloaders 410. In one embodiment, reference aerial images 256 are north aligned for convenience.

Once UAV 105 is provisioned with its mission data, it flies its mission (process block 310). This mission may include flying to a point of interest (POI) such as waypoint pickup area 101, delivery destination 115, or terminal area 100 (decision block 315). At the POI, UAV 105 acquires a current aerial image 415 (see FIG. 4B) of the ground area below UAV 105 with onboard camera system 205 while its flies above the ground area (process block 320). Current aerial image 415 may not be north aligned dependent upon the orientation of UAV 105.

In a process block 325, UAV 105 selects the appropriate asset map 255 (including reference aerial image 256) from its asset library 257. This selection may be based upon a variety of data including one or more of its GNSS location, progress through its mission plan, its altitude, the current time, and in one embodiment an embedding vector. As previously mentioned, reference aerial images 256 may be indexed to vector embeddings to facilitate similarity searching. In this embodiment, UAV 105 may generate a current vector embedding based on current aerial image 415, and then use this current vector embedding to perform a similarity search against the reference vector embeddings in asset library 257 to identify the most appropriate asset map 255 with the most similar reference aerial image 256. In yet another embodiment, the appropriate asset map 255 is selected based upon GNSS location and altitude.

With the most appropriate asset map 255 selected, homography estimating tool 250 proceeds to map correspondences between reference aerial image 400 and current aerial image 415 (process block 330). This mapping matches feature-to-feature between the two aerial images, as illustrated in FIG. 4C. The mapping may include executing a feature extractor (process block 331) on each of the aerial images and then executing a feature matcher (process block 333) on the extracted features to obtain a homography between the reference aerial image 400 and the current aerial image 415.

With features matched and the correspondences mapped, current aerial image 415 can be annotated with one or more annotations from the reference aerial image 400 of the selected asset map 255 (process block 335). FIG. 4D illustrates a current aerial image 420 that is annotated to identify fiducial navigation markers 405 and autoloaders 410. In the illustrated embodiment of FIG. 4D, the annotations are depicted as boxes around these assets; however, the annotations may assume other shapes, patterns, colors, etc. In one embodiment, the annotations are implemented as metadata/descriptors referencing pixel groups or objects within current aerial image 420 and need not include visual accents on the current aerial image itself. Annotating the real-time current aerial images 207 (or 415) to generate annotated current aerial image 420 provides valuable information from asset maps 255 to object detection models 245. The asset map labels inform the segmentation performed by object detection models 245 when detecting and identifying the various on-ground assets.

In a process block 340, UAV 105 analyzes current aerial image 415 with one or more object detection models 245 to detect one or more objects positioned at the ground area. Object detection models 245 may include semantic segmentation ML models trained to detect autoloaders, fiducial navigation markers, or otherwise. Detection and identification of the various assets enables navigation controller 225 to navigate visually relative to these assets using feedback from its various vision-based navigation modules 220. However, in some situations, object detection models 245 alone may not be able to accurately detect all assets. Lack of detection may be due to a variety of reasons including altitude, glare from sunlight, shadows, insufficiently distinct background, or other optical illusions. Accordingly, embodiments described herein use asset maps 255 to validate, or otherwise inform, object detection models 245 to enhance asset detection by its vision-based navigation modules. In other words, the annotations sourced from asset map 400 and mapped to current aerial map 420 are used to validate or inform the real-time detections by object detection models 245 running onboard UAV 105 as it hovers over the ground area (process block 345).

Validation of the real-time detections using the mapped annotations may be accomplished by a variety of different techniques. In one embodiment, the annotations delineate a region (e.g., box) on current aerial image 420 that is annotated to be a specific type of asset (e.g., fiducial navigation marker 405, autoloader 410, etc.). The annotated area may be used to affirm or upweight a detection of a corresponding asset by one or more of object detection models 245 that overlaps with the annotated area in the aerial image. Correspondingly, real-time asset detections by object detection models 245 that do not overlap with an annotation sourced from asset maps 255 may be entirely masked (i.e., ignored as a false detection) or downweighted so that those detections are interpreted to be less certain by navigation controller 225 when making navigation decisions. In other words, navigation controller 225 may navigate UAV 105 relative to detected objects at a ground area based upon the real-time detections output from object detection models 245 and based upon the mappings of the correspondences between reference aerial images 256 and current aerial images 207 using homography estimating tool 250. In one embodiment, navigation controller 225 may only accept an object, for visual navigation with respect thereto, after double registration of the object by one of object detection models 245 and a corresponding annotation sourced from one of asset maps 255. In other words, navigation controller 225 accepts a detect object for relative visual navigation thereto, if the object detection by an object detection model 245 registers to a corresponding annotation of the same object type/category sourced from an asset map via homography.

Process 300 continues to a process block 355 on FIG. 3B via off-page reference 350. Homography estimating tool 250 may be used for other navigation functions than just validating object detection models 245. In fact, homography estimating tool 250 may be used to perform an optional homography based localization of UAV 105 when flying above a particular ground area. In one embodiment, asset maps 255 may include reference aerial images 256 that are geo-registered or otherwise include geolocated pixels. In such cases, the homography based mapping of reference aerial images 256 to current aerial images 207 can be used to annotate the current aerial images 207 (or 415) with geolocation metadata, which in turn is used to geolocate UAV 105 over the ground.

To geolocate UAV 105 based upon a homography mapping by homography estimating tool 250, the pixel within the current aerial image 207 that corresponds to the location on the ground that is directly below UAV 105 when capturing the current aerial image 207 should be identified. This pixel is referred to as the gravity aligned pixel. In a process block 355, the gravity aligned pixel is identified based upon an attitude of UAV 105 when capturing the current aerial image 207. In one embodiment, an attitude measurement may be acquired from a perception sensor disposed onboard UAV 105, such as IMU 210. The angle of UAV 105 relative to the measured gravity vector may be used to determine the pixel offset (magnitude and direction) from a center of the current aerial image 207. This offset calculation may be based upon a lookup table or directional scalar. With the gravity aligned pixel determined, it is matched to the geolocation data or geolocated pixel from the reference aerial image 256 using homography estimating tool 250 (process block 360), which in turn localizes UAV 105 in the world frame above the ground area (process block 365).

Homography based localization may be well suited for higher altitudes where the assets or reference objects are too small to identify by object detection models 245, but distinctive features (roofs, roads, driveways, trees, etc.) in the reference aerial images 256 and current aerial images 207 can still be extracted and matched. Accordingly, in one embodiment, UAV 105 may initially navigate using homography mapping between reference and current aerial images and then transition to navigating based upon detections from object detection models 245 as it descends toward the ground (process block 370) and is able to detect and identify reference objects. In one embodiment, vision-based navigation above a threshold AGL altitude may be exclusively based upon homography mappings and then transition to detections based upon object detection models 245 as those detections become more reliable (process block 375). Thus vision-based navigation that is relative to objects on the ground may be based upon both homography mappings and semantic/object ML detections (process block 380).

The transition between the two vision-based techniques may be abrupt or gradual. In an abrupt transition model, the transition may occur at a threshold AGL altitude or when the object detection model confidence reaches a threshold value. In a gradual transition model, weights or biases may be applied to the homography localization and object detection model detections adjusting the influence these two techniques have over the navigation decisions made by navigation controller 225. These weights/biases may then be gradually adjusted in favor of detections by the object detection models as UAV 105 descends and the ground objects or assets fill a larger portion of the FOV of onboard camera system 205.

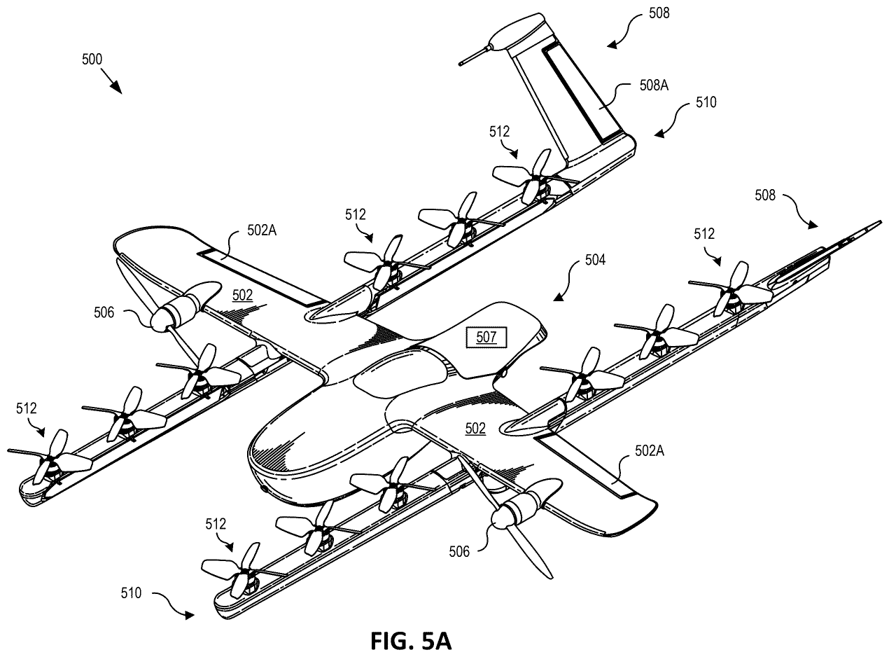

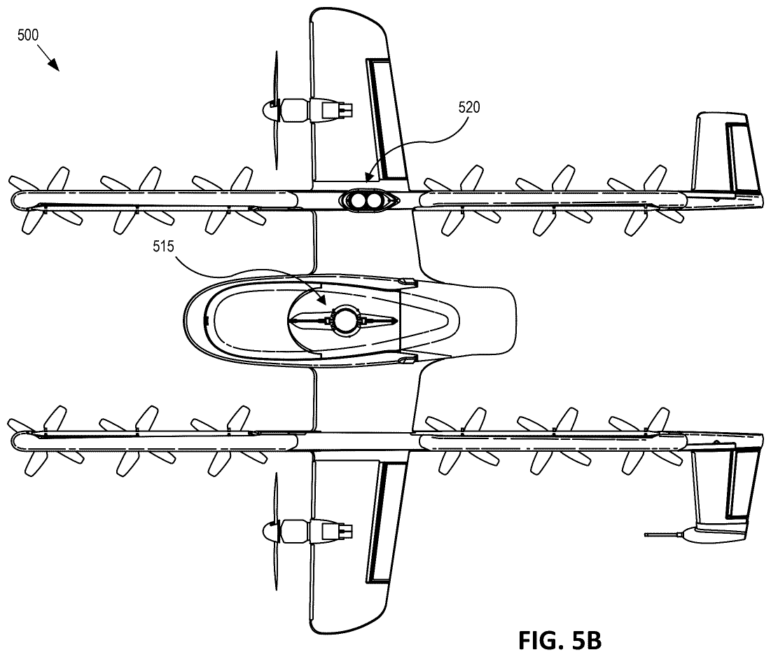

FIGS. 5A and 5B illustrate a UAV 500 that is well-suited for delivery of packages, in accordance with an embodiment of the disclosure. FIG. 5A is a topside perspective view illustration of UAV 500 while FIG. 5B is a bottom side plan view illustration of the same. UAV 500 is one possible implementation of UAVs 105 illustrated in FIG. 1, although other types of UAVs may be implemented for a UAV delivery service as well.

The illustrated embodiment of UAV 500 is a vertical takeoff and landing (VTOL) UAV that includes separate propulsion units 506 and 512 for providing horizontal and vertical propulsion, respectively. UAV 500 is a fixed-wing aerial vehicle, which as the name implies, has a wing assembly 502 that can generate lift based on the wing shape and the vehicle's forward airspeed when propelled horizontally by propulsion units 506. The illustrated embodiment of UAV 500 has an airframe that includes a fuselage 504 and wing assembly 502. In one embodiment, fuselage 504 is modular and includes a battery module, an avionics module, and a mission payload module. These modules are secured together to form the fuselage or main body.

The battery module (e.g., fore portion of fuselage 504) includes a cavity for housing one or more batteries for powering UAV 500. The avionics module (e.g., aft portion of fuselage 504) houses flight control circuitry of UAV 500, which may include a processor and memory, communication electronics and antennas (e.g., cellular transceiver, wifi transceiver, etc.), and various sensors (e.g., GNSS sensor, an inertial measurement unit, a magnetic compass, a radio frequency identifier reader, etc.). Collectively, these functional electronic subsystems for controlling UAV 500, communicating, and sensing the environment may be referred to as a control system 507. The mission payload module (e.g., middle portion of fuselage 504) houses equipment associated with a mission of UAV 500. For example, the mission payload module may include a payload actuator 515 (see FIG. 5B) for holding and releasing an externally attached payload (e.g., package for delivery). In some embodiments, the mission payload module may include camera/sensor equipment (e.g., camera, lenses, radar, lidar, pollution monitoring sensors, weather monitoring sensors, scanners, etc.). In FIG. 5B, an onboard camera 520 (e.g., onboard camera system 205) is mounted to the underside of UAV 500 to support a computer vision system (e.g., stereoscopic machine vision) for visual triangulation and navigation as well as operate as an optical code scanner for reading visual codes affixed to packages. These visual codes may be associated with or otherwise match to delivery missions and provide the UAV with a handle for accessing destination, delivery, and package validation information. Of course, onboard camera 520 may alternatively be integrated within fuselage 504.

As illustrated, UAV 500 includes horizontal propulsion units 506 positioned on wing assembly 502 for propelling UAV 500 horizontally. UAV 500 further includes two boom assemblies 510 that secure to wing assembly 502. Vertical propulsion units 512 are mounted to boom assemblies 510 and provide vertical propulsion. Vertical propulsion units 512 may be used during a hover mode where UAV 500 is descending (e.g., to a delivery zone), ascending (e.g., at initial launch or following a delivery), or maintaining a constant altitude. Stabilizers 508 (or tails) may be included with UAV 500 to control pitch and stabilize the aerial vehicle's yaw (left or right turns) during cruise. In some embodiments, during cruise mode vertical propulsion units 512 are disabled or powered low and during hover mode horizontal propulsion units 506 are disabled or powered low.

During flight, UAV 500 may control the direction and/or speed of its movement by controlling its pitch, roll, yaw, and/or altitude. Thrust from horizontal propulsion units 506 is used to control air speed. For example, the stabilizers 508 may include one or more rudders 508A for controlling the aerial vehicle's yaw, and wing assembly 502 may include elevators for controlling the aerial vehicle's pitch and/or ailerons 502A for controlling the aerial vehicle's roll. Rudders 508A and ailerons 502A are referred to as control surfaces. While the techniques described herein are particularly well-suited for VTOLs providing an aerial delivery service, it should be appreciated that the techniques described herein are generally applicable to a variety of aircraft types (not limited to VTOLs) providing a variety of services or serving a variety of functions beyond package deliveries.

Many variations on the illustrated fixed-wing aerial vehicle are possible. For instance, aerial vehicles with more wings (e.g., an “x-wing” configuration with four wings), are also possible. Although FIGS. 5A and 5B illustrate one wing assembly 502, two boom assemblies 510, two horizontal propulsion units 506, and six vertical propulsion units 512 per boom assembly 510, it should be appreciated that other variants of UAV 500 may be implemented with more or less of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method performed by an unmanned aerial vehicle (UAV), the method comprising:
storing an asset map of a ground area, wherein the asset map includes a reference aerial image of the ground area annotated with labels describing reference objects depicted in the reference aerial image;
acquiring a current aerial image of the ground area with an onboard camera system of the UAV while the UAV is flying above the ground area;
mapping correspondences between the reference aerial image and the current aerial image using a homography estimating tool executing onboard the UAV;
analyzing the current aerial image with an object detection model to detect a first object positioned at the ground area; and
validating or informing a detection of the first object by the object detection model based on the mapping of the correspondences.

2. The method of claim 1, further comprising:
annotating the current aerial image with one or more annotations corresponding to one or more of the reference objects from the asset map based on the mapping,
wherein validating or informing the detection of the first object by the object detection model is based on the annotating.

3. The method of claim 2, wherein validating or informing the detection of the first object by the object detection model comprises:
affirming or upweighting the detection of the first object when the detection of the first object overlaps with one of the annotations sourced from the asset map.

4. The method of claim 2, wherein validating or informing the detection of the first object by the object detection model comprises:
masking or downweighting the detection of the first object when the detection of the first object does not overlap with one of the annotations sourced from the asset map.

5. The method of claim 2, further comprising:
navigating the UAV relative to the first object based upon the detection of the first object by the object detection model and based upon the mapping of the correspondences between the reference aerial image and the current aerial image using the homography estimating tool.

6. The method of claim 5, wherein the UAV navigates with reference to the first object only after the detection of the first object by the object detection model registers to a corresponding one of the annotations sourced from the asset map.

7. The method of claim 5, further comprising:
transitioning from navigating the UAV based upon the mapping to navigating the UAV based upon the detection from the object detection model as an above ground level (AGL) altitude of the UAV decreases.

8. The method of claim 1, further comprising:
making navigation decisions for the UAV based upon one or both of the detection of the first object by the object detection model or the mapping from the homography tool; and
decreasing an influence of the mapping on the navigation decisions, relative to the detection of the first object by the object detection model, as an above ground level (AGL) altitude of the UAV decreases.

9. The method of claim 1, wherein the asset map is annotated with geolocation labels, the method further comprising:
identifying a gravity aligned pixel in the current aerial image based upon an attitude measurement output from a sensor disposed onboard the UAV, wherein the gravity aligned pixel corresponds to a portion of the current aerial image disposed immediately below the UAV along a gravity vector passing through the UAV;
matching the gravity aligned pixel to a corresponding geolocated pixel in the reference aerial image of the asset map based upon the mapping; and
localizing the UAV based upon the matching.

10. The method of claim 1,
wherein the reference objects include at least one of a charging pad adapted for charging the UAV, a fiducial navigation marker adapted for visual navigation of the UAV, or an autoloader adapted to load a package onto the UAV, and
wherein the object detection model comprises at least one of a machine learning (ML) charge pad detector, a ML fiducial marker detector, or a ML autoloader detector.

11. The method of claim 1, further comprising:
storing a library of asset maps, including the asset map, each corresponding to a different aerial image of the ground area captured from a different altitude or captured at a different time of day; and
selecting the asset map from the library of asset maps based upon at least one of a current altitude of the UAV or a current time of day when acquiring the current aerial image.

12. The method of claim 1, further comprising:
storing a library of asset maps, including the asset map, each corresponding to a different aerial image of the ground area, wherein the asset maps are indexed to reference vector embeddings; and
generating a current vector embedding based on the current aerial image; and
selecting the asset map from the library of asset maps by comparing the current vector embedding to the reference vector embeddings.

13. At least one non-transitory machine-accessible storage medium that provides instructions that, when executed by an unmanned aerial vehicle (UAV), will cause the UAV to perform operations comprising:
storing an asset map of a ground area, wherein the asset map includes a reference aerial image of the ground area annotated with labels describing reference objects depicted in the reference aerial image;
acquiring a current aerial image of the ground area with an onboard camera system of the UAV while the UAV is flying above the ground area;
mapping correspondences between the reference aerial image and the current aerial image using a homography estimating tool executing onboard the UAV;
analyzing the current aerial image with an object detection model to detect a first object positioned at the ground area; and
validating or informing a detection of the first object by the object detection model based on the mapping of the correspondences.

14. The at least one non-transitory machine-accessible storage medium of claim 13, wherein the operations further comprise:
annotating the current aerial image with one or more annotations corresponding to one or more of the reference objects from the asset map based on the mapping,
wherein validating or informing the detection of the first object by the object detection model is based on the annotating.

15. The at least one non-transitory machine-accessible storage medium of claim 14, wherein validating or informing the detection of the first object by the object detection model comprises:
affirming or upweighting the detection of the first object when the detection of the first object overlaps with one of the annotations sourced from the asset map.

16. The at least one non-transitory machine-accessible storage medium of claim 14, wherein validating or informing the detection of the first object by the object detection model comprises:
masking or downweighting the detection of the first object when the detection of the first object does not overlap with one of the annotations sourced from the asset map.

17. The at least one non-transitory machine-accessible storage medium of claim 14, wherein the operations further comprise:
navigating the UAV relative to the first object based upon the detection of the first object by the object detection model and based upon the mapping of the correspondences between the reference aerial image and the current aerial image using the homography estimating tool.

18. The at least one non-transitory machine-accessible storage medium of claim 17, wherein the UAV navigates with reference to the first object only after the detection of the first object by the object detection model registers to a corresponding one of the annotations sourced from the asset map.

19. The at least one non-transitory machine-accessible storage medium of claim 17, wherein the operations further comprise:
transitioning from navigating the UAV based upon the mapping to navigating the UAV based upon the detection from the object detection model as an above ground level (AGL) altitude of the UAV decreases.

20. The at least one non-transitory machine-accessible storage medium of claim 13, wherein the operations further comprise:
making navigation decisions for the UAV based upon one or both of the detection of the first object by the object detection model or the mapping from the homography tool; and
decreasing an influence of the mapping on the navigation decisions, relative to the detection of the first object by the object detection model, as an above ground level (AGL) altitude of the UAV decreases.

21. The at least one non-transitory machine-accessible storage medium of claim 13, wherein the asset map is annotated with geolocation labels, wherein the operations further comprise:
identifying a gravity aligned pixel in the current aerial image based upon an attitude measurement output from a sensor disposed onboard the UAV, wherein the gravity aligned pixel corresponds to a portion of the current aerial image disposed immediately below the UAV along a gravity vector passing through the UAV;
matching the gravity aligned pixel to a corresponding geolocated pixel in the reference aerial image of the asset map based upon the mapping; and
localizing the UAV based upon the matching.

22. The at least one non-transitory machine-accessible storage medium of claim 13, wherein:
the reference objects include at least one of a charging pad adapted for charging the UAV, a fiducial navigation marker adapted for visual navigation of the UAV, or an autoloader adapted to load a package onto the UAV, and
the object detection model comprises at least one of a machine learning (ML) charge pad detector, a ML fiducial marker detector, or a ML autoloader detector.
